(19) United States
(12) Patent Application Publication
(10) Pub. No.: US 2011/0102298 A1
(43) Pub. Date: May 5, 2011

(54) SCREEN

(76) Inventors: Willi Kussel, Werne (DE); Peter Rarms, Wohnsitz (DE)

(21) Appl. No.: 12/988,732

(22) PCT Filed: Apr. 21, 2009
(86) PCT No.: PCT/DE2009/000513

§ 371 Date: Dec. 30, 2010

(30) Foreign Application Priority Data
Apr. 21, 2008 (DE) 10 2008 020 033.6

(51) Int. Cl. G09G 5/00

(52) U.S. Cl. 345/1.1

(57) ABSTRACT

A screen for displaying commands, functions, operating states, positions, and/or functional states (operating data, data) on machines or systems (system) comprises several partial screens (8.1 to 8.4) that are arranged on a single plane. A complete screen control device (partial screen control device 10.1 to 10.4) encompassing the program for controlling the partial screen is allocated to each partial screen. The data is retrieved from the data collecting memory and distributed to the partial screen control devices by means of a data collector and a joint master control device in order to be displayed on at least one of the partial screens according to a pattern that can be entered using a keypad.

A screen according to the generic part of claim 1 to display commands, functions, operational states, positions and/or functional states (operating data, data) with a plant computer for controlling and monitoring and with a screen control device is today standard equipment for complex machines or plants. A screen for underground mining is known from DE 10 2006 12 693 A1 (TBT2509).

In that case the screen is suitable merely to illustrate one picture, that can contain details and cross-fadings of other pictures, however, it is not complete. In addition, details and cross-fadings have to be pre-programmed, so that no adaptation to suit the actual needs and requirements of the actual operation is possible.

As picture within the scope of this application, be it actual stationary or live picture of the plant or parts of the plant, pictorial, schematic or diagrammatic illustration of functions and sequences, illustration of commands and command sequences, operational data and parameters as individual data, data columns and tables, every illustration on the screen that is required for the control or monitoring of the plant, is understood. The contents and the kind of the pictorial illustrations are determined solely by the design of the plant, the sensors used and recording equipment and the flow of data to and from the plant computer.

The task of the invention is the production of a screen with screen control, that is particularly suitable for a plant computer of complex plants and allows the simultaneous parallel showing of a plurality of pictures and with arbitrary changing and arbitrary sequencing next to one another and without influencing and overlapping one another.

The solution according to claim 1 is suitable, above all, for complex plants requiring an intensive monitoring of a plurality parts and functions of the plant. Such a plant is, in particular, the devices used for longwall mining of coal in a mine according to claim 5.

The partial screen control devices are preferably identical as far as construction, function, structure, software and programming are concerned. The data of the plant, e.g. of the longwall, is collected in the data collector, that is assigned to the plant computer and preferably accommodated in the same computer housing. The data of the data collector is disseminated via the master computer (master control device) to the computers of the displays (partial screen control devices) according to the specifications of an input device. The input device can be a data memory that contains a program for the dissemination of the pictures. One deals here in particular with a keyboard (claim 2), that has the advantage that the contents, the manner of illustration and the desired partial screen can be always selected by it.

In the development according to claims 3 and 4, 2×2 or 2+3 displays (partial screens), for example, can be arranged in one plane in the cover of the computer housing, visible from the outside. Such an arrangement is suitable both for the illustration of a plurality of pictures as well as of a single picture that is distributed to two or several or all partial screens and is combined. Thus the free partial screens can be used for further pictures, which are related to other functional elements of the plant.

Claim 5 proposes the application of the invention for a plant of the greatest complexity, namely for the devices for coal mining in longwall operation of an underground mine. Such a plant comprises, in particular, the extraction machine that can travel along the coal face, the more than 100 timbering units (shields 11) that are constructed along the longwall, the control device for the timbering with the central control unit (1), the longwall control device (4, 5) at the end of the longwall to control the mining functions of the extraction machine and the timbering functions of the timbering units in the sense of clearing, stepping setting as well as the shield control devices (12), one of each being positionwise and functionally allocated to a timbering unit each for the conversion and transmission of timbering commands of the longwall control device and for transferring data, while the longwall control device and the shield control devices are connected for the purpose of transmitting commands and data (busbar (3)). In this case the plant computer is the longwall control device, that as data collecting memory at the same time is equipped with a read-only-memory component for combining, collecting and possibly storing the operational data of the timbering and mining functions carried out in the longwall.

The longwall control device or one longwall control device each is situated as intrinsically safe display computer at the end of the longwall and communicate with the central computer and the shield controls. Claim 6 relates to a development, that is particularly suitable for underground mining and is applicable, above all, to the longwall control device or the longwall control devices at the ends of a longwall. By virtue of this the heavy computer housings, hitherto used and difficult to manoeuvre, can be replaced by light housings which can be also so positioned that on one of their side walls, preferably on the cover, the displays are provided in a rectangular grid, however the partial screen controls can be so provided on the rear of the displays in the interior of the housing, that by folding the cover upward the partial screen controls become visible and accessible for maintenance or replacement. For this purpose the plant computer has an “intrinsically safe” construction, whereby they have such a low energy and current requirement that no sparks and no inadmissible heating up will occur and there will be no danger of explosion either from the computer housing with the light construction.

The keyboard connected to the master control device can be also visibly and easily accessibly mounted on the cover of the computer housing and used without external leads to the computer housing to set the parameters of the master and to call up all functions of the display system.

The master carries out the dissemination of the available information on the displays. The master control device can be so programmed/parameters set by the keyboard, that all (e.g. 4) displays will represent a single picture or, for example, two adjacent displays show one picture and the other displays a different picture each or all displays show different pictures. The computers, as intrinsically safe display computers are at the ends of the longwall and communicate with the central computer and the shield controls.

In the drawing a timbering control device is schematically illustrated as an example and the preferred object of application of the invention. It shows in:

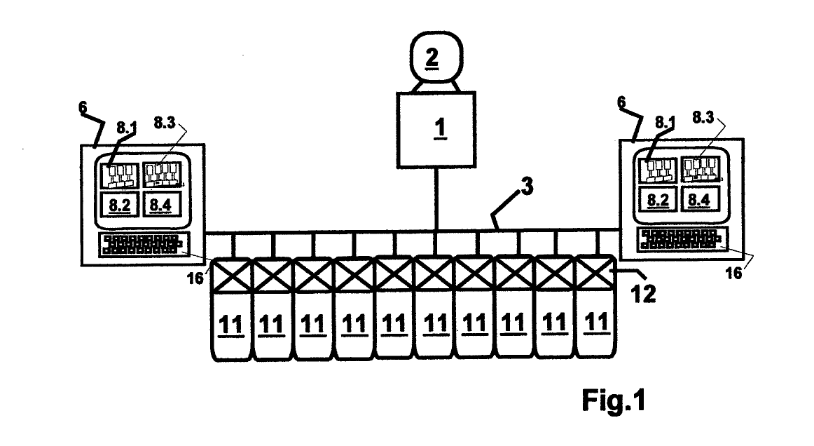

FIG. 1—the diagram of a mining operation with individual timbering units 11 and longwall control devices,

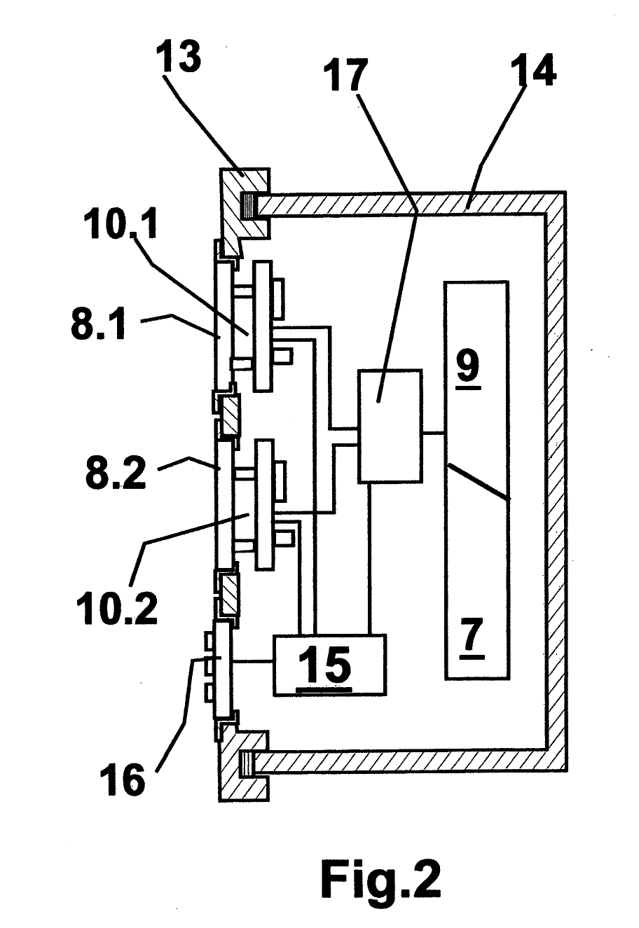

FIG. 2—a section through the housing 14 with the cover 13 of the plant computer/longwall control device 6.

The reference numeral 1 designates the above-ground central control device, that also has a screen 2. The central control device is connected, via a busbar 3, to a longwall control device, preferably two longwall control devices 6 that are essentially identical as far as construction and function are concerned which are underground at the ends of the longwall and in this case serve as plant computers. The plant computers 6 are connected via a busbar 3 and respective branch lines to the shield control devices 12 of the timbering units 11.

The plant computers/longwall control devices 6 are described in the following. Each plant computer is accommodated in a housing and is fitted with a screen 8. The plant computer/longwall control device (6) has an “intrinsically safe” construction. This means that the circuits and components are so constructed, that they can be operated with such a low energy and such a low current, that even in the case of malfunctions or damages or defects no spark will be formed and no inadmissible heating up is possible and consequently there is no danger of explosion even in underground operation. For this reason the computer housing can be constructed as a light sheet metal box with a sheet metal thickness of less than 10 mm, in contrast to conventional computer housings of “intrinsically not safe” longwall control devices. In FIGS. 2.1 and 2.2 the housing 14 with the cover 13 is illustrated in the enclosed state.

Each screen comprises partial screens 8.1, 8.2, 8.3, 8.4, each of them being the same size and provided in a rectangular flat grid. As FIG. 2 shows, the partial screens are provided on the outward facing side of the cover 13, with which the housing 14 of the plant computer/longwall control device 6 can be enclosed tightly sealed.

In addition to the computer capacity 9 and the processors each longwall control device 6 also has a memory 7 that as read-only-memory comprises digital memory components constructed as semiconductors, in which the function, operating and control programs, required by the computer/longwall control device 6 to control the timbering function, are stored. Just like the central control device 1, each longwall control device 6 is equipped with a keyboard, with which not only the timbering commands but, as described in the following, also commands to call up data and to determine the type of illustrations on one or several of the partial screens 8 can be entered.

To each partial screen a complete screen control device, a so-called partial screen control device 10.1 to 10.4 is assigned with the program to control the partial screen. The partial screen control devices 10.1 to 10.4 are mounted on the rear of the associated partial screen. All partial screen control devices have preferably identical construction, provided with identical software and programming to display the data entered.

Each partial screen control device is connected, via a lead, to a master control device 15, that is common for all partial screen control devices, and is controlled by same. The master control device 15 is also accommodated in the housing 14 of the plant computer 6. The master control device 15 can be a component of one of the partial screen control devices.

The master control device 15 is controlled and programmed (parameters set) by the keyboard 16, with which it is connected via a group of leads. By virtue of this the master control device 15 can disseminate the data collected in a data collector 17 to the individual partial screen controls of the plant computer in accordance with the wish of the operator and determine the picture to be shown on each partial screen. The data collector (data collecting memory) 17 is a data memory assigned to the plant computer 6, in which all data, obtained in the plant or in a part of the plant, that can be displayed on a screen, in particular commands, measured values, photos taken, etc. can be so collected and/or stored, that in accordance of the wishes entered in the master control device 15 by the operator they can be called up, distributed to one or several partial screen controls of the plant computer and displayed on the relevant partial screens according to the pattern that can be entered.

### REFERENCE NUMERALS

1. Central control device 1
2. Screen 2
3. Busbar 3
4. 4
5. 5
6. Plant computer, Longwall computer, Computer unit, Processor, Process computer 6
7. Memory 7
8. Screen 8 8.1-8.4 Partial screens
9. Fixed storage 9, Read-only-memory 9
10. Screen processor, Partial screen processor, Partial screen control device 10.1 to 10.4
11. Timbering units 11
12. Shield control devices 12
13. Cover
14. Computer housing, Housing, Sheet metal box
15. Master control device 15
16. Keyboard 16
17. Data collector 17

1-6. (canceled)

7. A screen to display commands, functions, operational states, positions and/or functional states (operating data, data) on machines or plants (plant) with a plant computer for controlling and monitoring the plant and with a screen control device with the program to control the screen according to the specifications of the plant computer, said screen comprising:
a plurality of independent and separate partial screens, wherein as screen control device a complete partial screen control device is assigned to each partial screen, the partial screen control device is independent from every other screen control device and to control the relevant partial screen is equipped with a program that is independent from the others, that a data collector for combining, collecting and possibly storing the data occurring in the plant is assigned to the plant computer, and wherein a common master control device is assigned to the partial screen control devices, the master control device calling up the data from the data collecting memory according to a program that can be entered and disseminates to at least one of the partial screens to be displayed according to a pattern that can be entered.

8. The screen according to claim 7, wherein via an input device (keyboard) a parameter of the master control device can be set for the purpose of calling up specified operational data and to disseminate the called up operational data to one or several specified partial screen control devices and partial screens.

9. The screen according to claim 7, wherein the partial screens are provided in a common plane, in particular on a side wall, in particular on a cover of a computer housing, where they are visible from the outside and on their rear they are provided with the components and circuit boards of their respective partial screen control device.

10. The screen according to claim 7, wherein the partial screens of identical size are provided in a rectangular flat grid.

11. The screen according to claim 7, wherein the plant comprises devices for coal mining in longwall operation of an underground mine, in particular an extraction machine that can travel along a coal face, and/or timbering units (shields 11) that are set up along the longwall, a timbering control device with an above-ground central control unit, the longwall control device at the end of the longwall to control mining functions of the extraction machine and the timbering functions of the timbering units in the sense of clearing, stepping, setting as well as the shield control devices, each positionwise and functionally allocated to a timbering unit for the conversion and transmission of timbering commands of the longwall control device and for transferring data, wherein the plant computer is the longwall control device, wherein as data collecting memory at the same time is equipped with a read-only-memory component for combining, collecting and possibly storing the operational data of the timbering and/or mining functions carried out in the longwall.

12. The screen according to claim 7, wherein the plant computer/longwall control device is designed as “intrinsically safe”, whereby the circuits and components are so designed that they can be operated with low energy and low current without the danger of sparks being formed and of inadmissible heating up, and wherein the computer housing can be constructed as a sheet metal box.
